(19) United States
(12) Patent Application Publication
(10) Pub. No.: US 2012/0191745 A1
(43) Pub. Date: Jul. 26, 2012

(54) Synthesized Suggestions for Web-Search Queries

(75) Inventors: Emre Velipasaoglu, San Francisco, CA (US); Alpa Jain, San Jose, CA (US); Umut Ozertem, Sunnyvale, CA (US)

(73) Assignee: Yahoo!, Inc., Sunnyvale, CA (US)

(21) Appl. No.: 13/012,795

(22) Filed: Jan. 24, 2011

(51) Int. Cl. G06F 17/30

(52) U.S. Cl. 707/767; 707/E17.074

(57) ABSTRACT

Data-mining software receives a user query as an input and segments the user query into a number of units. The data-mining software then drops terms from a unit using a Conditional Random Field (CRF) model that combines a number of features. At least one of the features is derived from query logs and at least one of the features is derived from web documents. The data-mining software then generates one or more candidate queries by adding terms to the unit. The added terms result from a hybrid method that utilizes query sessions and a web corpus. The data-mining software also scores each candidate query on well-formedness of the candidate query, utility, and relevance to the user query. Then the data-mining software stores the scored candidate queries in a database for subsequent display in a graphical user interface for a search engine.

### BACKGROUND

Major search engines provide query suggestions to assist users with effective query formulation and reformulation. In the past, the primary, if not the only, source for query suggestions has been the query logs maintained by the search engines.

Of course, query logs only record observations of previous query sessions. Consequently, query logs are of only limited usefulness when a search engine is presented with a query that has not been observed before.

In the search-engine literature, “coverage” refers to the number of such non-observed queries for which users are provided with query suggestions. Broad coverage, in and of itself, is of little value to the user, if the quality of the query suggestions is low.

### SUMMARY

In an example embodiment, a processor-executed method is described for the synthesizing of suggestions for web-search queries. According to the method, data-mining software receives a user query as an input and segments the user query into a number of units. The data-mining software then drops terms from a unit using a labeling model that combines a number of features. At least one of the features is derived from query logs and at least one of the features is derived from web documents. The program generates one or more candidate queries by adding terms to the unit. The added terms result from a hybrid method based on co-occurrence of terms in query sessions, distributional similarity of terms in web documents, and term substitutions from other user queries that lead to a common uniform resource locator (URL). The program also scores each candidate query on well-formedness of the candidate query, utility, and relevance to the user query. For this scoring, relevance depends on a similarity measure, among other things. Then the data-mining software stores the scored candidate queries in a database for subsequent display in a graphical user interface for a search engine.

In another example embodiment, an apparatus is described, namely, a computer-readable storage medium which persistently stores a program for the synthesizing of suggestions for web-search queries. The program might be a module in data-mining software. The program receives a user query as an input and segments the user query into a number of units. The program then drops terms from a unit using a labeling model that combines a number of features. At least one of the features is derived from query logs and at least one of the features is derived from web documents. The program generates one or more candidate queries by adding terms to the unit. The added terms result from a hybrid method based on co-occurrence of terms in query sessions, distributional similarity of terms in web documents, and term substitutions from other user queries that lead to a common uniform resource locator (URL). The program also scores each candidate query on well-formedness of the candidate query, utility, and relevance to the user query. For this scoring, relevance depends on a similarity measure, among other things. Then the program stores the scored candidate queries in a database for subsequent display in a graphical user interface for a search engine.

In another example embodiment, a processor-executed method is described for the synthesizing of suggestions for web-search queries. According to the method, data-mining software receives a user query as an input and segments the user query into a number of units. The data-mining software then drops terms from a unit using a Conditional Random Field (CRF) model that combines a number of features, one of which is a standalone score for a term. Further, at least one of the features is derived from query logs and at least one of the features is derived from web documents. The data-mining software then generates one or more candidate queries by adding terms to the unit. The added terms result from a hybrid method that utilizes query sessions and a web corpus. The data-mining software also scores each candidate query on well-formedness of the candidate query, utility, and relevance to the user query. For this scoring, relevance depends on web-based-aboutness similarity, among other things. Then the data-mining software stores the scored candidate queries in a database for subsequent display in a graphical user interface for a search engine.

Other aspects and advantages of the inventions will become apparent from the following detailed description, taken in conjunction with the accompanying drawings, which illustrate by way of example the principles of the inventions.

### BRIEF DESCRIPTION OF THE DRAWINGS

FIG. 1 is a simplified network diagram that illustrates a website hosting a search engine, in accordance with an example embodiment.

FIG. 2 is a flowchart diagram that illustrates a process for synthesizing suggestions for web-search queries, in accordance with an example embodiment.

FIG. 3 shows a graphical user interface displaying query suggestions, in accordance with an example embodiment.

FIG. 4 shows a table of Conditional Random Field (CRF) features that might be used to remove a term of lower importance from a concept unit, in accordance with an example embodiment.

FIG. 5 shows descriptive statistics (e.g., co-occurrence of terms in query sessions and distributional similarity of terms in web documents) that are used to suggest terms for a candidate query suggestion, in accordance with an example embodiment.

FIG. 6 shows statistical language models and a class-based language model that are used to calculate a score for the well-formedness of a candidate query suggestion, in accordance with an example embodiment.

FIG. 7 shows similarity vectors (e.g., a click vector, a context vector, and a web-based-aboutness vector) that are used to calculate a score for relevance to a user query, in accordance with an example embodiment.

FIG. 8 shows a descriptive statistic (e.g., pairwise conditional utility) that is used to measure the utility of a candidate query suggestion, in accordance with an example embodiment.

### DETAILED DESCRIPTION

In the following description, numerous specific details are set forth in order to provide a thorough understanding of the exemplary embodiments. However, it will be apparent to one skilled in the art that the example embodiments may be practiced without some of these specific details. In other instances, process operations and implementation details have not been described in detail, if already well known.

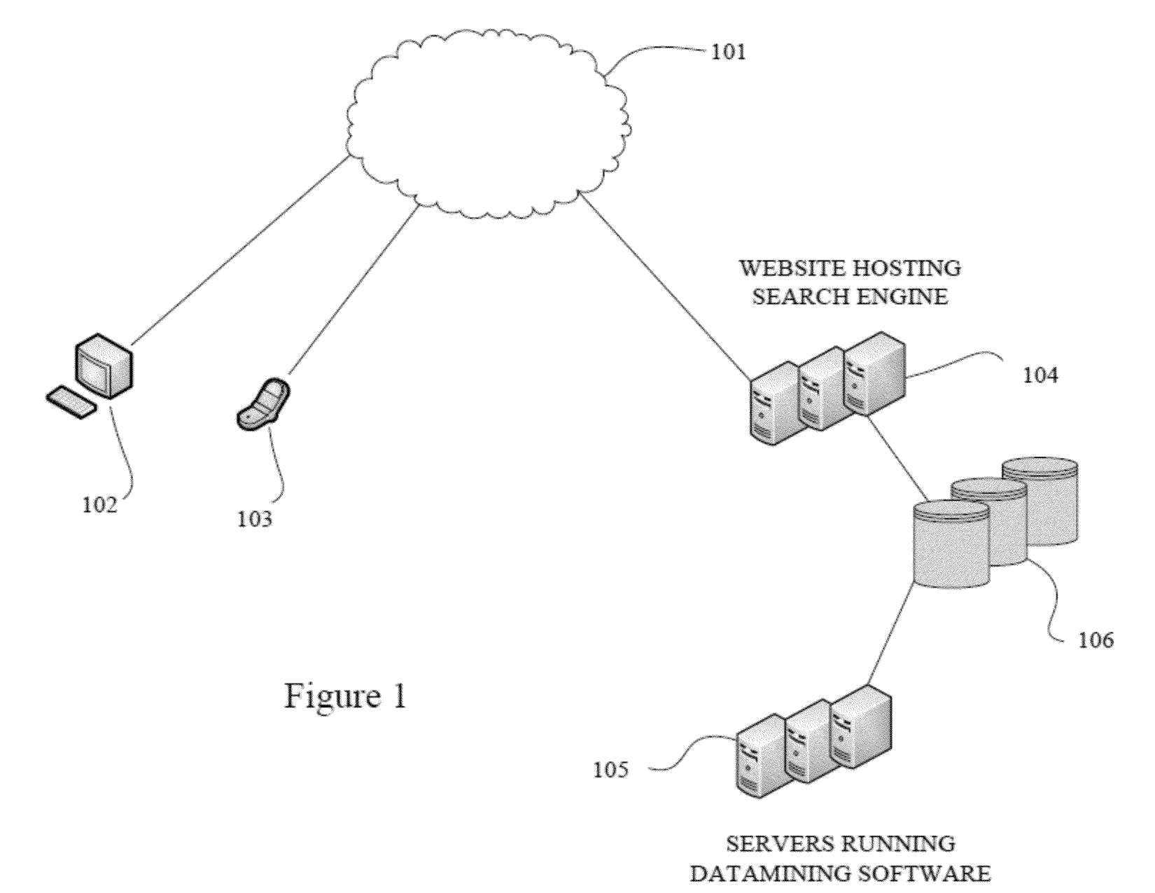

FIG. 1 is a simplified network diagram that illustrates a website hosting a search engine, in accordance with an example embodiment. As depicted in this figure, a personal computer 102 (which might be a laptop or other mobile computer) and a mobile device 103 (e.g., a smartphone such as an iPhone, Blackberry, Android, etc.) are connected by a network 101 (e.g., a wide area network (WAN) including the Internet, which might be wireless in part or in whole) with a website 104 hosting a search engine. In an example embodiment, the website 104 is composed of a number of servers connected by a network (e.g., a local area network (LAN) or a WAN) to each other in a cluster or other distributed system. The servers are also connected (e.g., by a storage area network (SAN)) to persistent storage 106, which might include a redundant array of independent disks (RAID) and which might be used to store web documents, query logs, or other data related to web searching, in an example embodiment.

Personal computer 102 and the servers in website 104 and cluster 105 might include (1) hardware consisting of one or more microprocessors (e.g., from the x86 family or the PowerPC family), volatile storage (e.g., RAM), and persistent storage (e.g., a hard disk), and (2) an operating system (e.g., Windows, Mac OS, Linux, Windows Server, Mac OS Server, etc.) that runs on the hardware. Similarly, in an example embodiment, mobile device 103 might include (1) hardware consisting of one or more microprocessors (e.g., from the ARM family), volatile storage (e.g., RAM), and persistent storage (e.g., flash memory such as microSD) and (2) an operating system (e.g., Symbian OS, RIM BlackBerry OS, iPhone OS, Palm webOS, Windows Mobile, Android, Linux, etc.) that runs on the hardware.

Also in an example embodiment, personal computer 102 and mobile device 103 might each include a browser as an application program or part of an operating system. Examples of browsers that might execute on personal computer 102 include Internet Explorer, Mozilla Firefox, Safari, and Google Chrome. Examples of browsers that might execute on mobile device 103 include Safari, Mozilla Firefox, Android Browser, and Palm webOS Browser. It will be appreciated that users of personal computer 102 and mobile device 103 might use browsers to communicate with search-engine software running on the servers at website 104. Examples of website 104 include a website that is part of google.com, bing.com, ask.com, yahoo.com, and blekko.com, among others.

Also connected (e.g., by a SAN) to persistent storage 106 is another cluster 105 of servers that execute data-mining software which might include (a) machine-learning software and (b) distributed-computing software such as Map-Reduce, Hadoop, Pig, etc. In an example embodiment, the software described in detail below might be a component of the data-mining software, receiving web documents and query logs from persistent storage 106 as inputs and transmitting query suggestions to persistent storage 106 as outputs. From there, the query suggestions might be accessed in real-time or near real-time by search-engine software at website 104 and transmitted to personal computer 102 and/or mobile device 103 for display in a graphical user interface (GUI) presented by a browser.

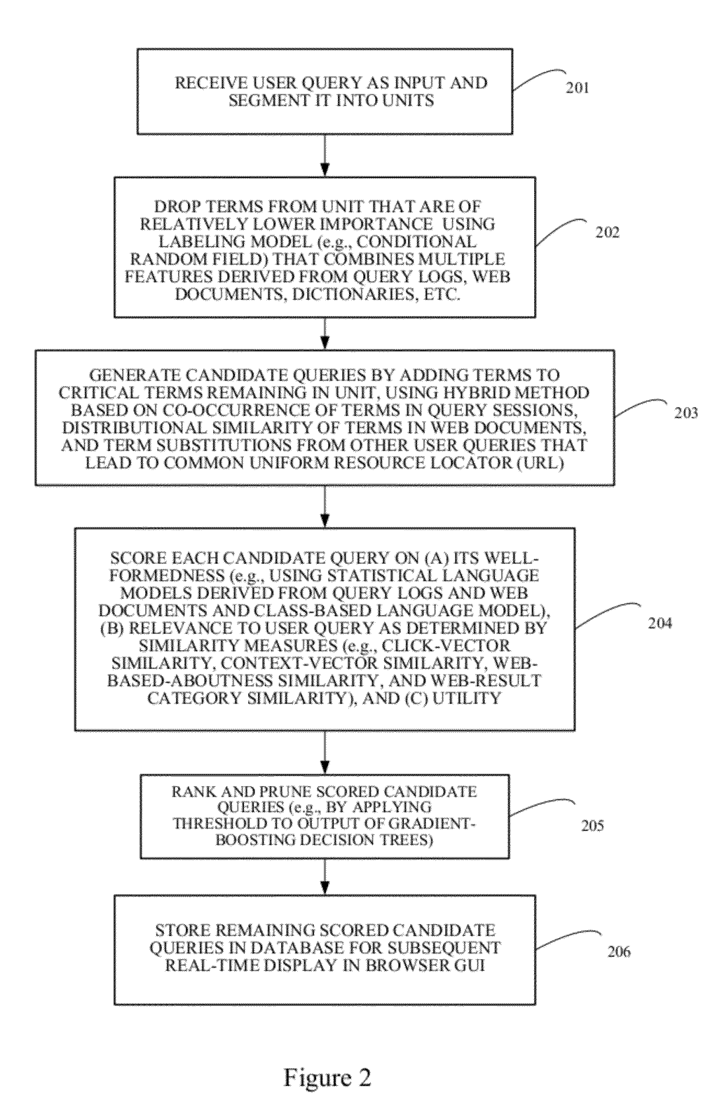

FIG. 2 is a flowchart diagram that illustrates a process for synthesizing suggestions for web-search queries, in accordance with an example embodiment. As indicated above, this process might be performed by data-mining software running on cluster 105 with access to web documents and query logs stored on persistent storage 106. As depicted in FIG. 2, the data-mining software receives a user query as an input (e.g., reads the user query from a query log) and segments it into units, in operation 201. As used in this disclosure, “units” refers to concept units as described in greater detail in co-owned U.S. Pat. No. 7,051,023 by Kapur et al., which is hereby incorporated by reference. In operation 202, the data-mining software drops terms from a unit that are of lower relative importance using a labeling model (e.g., conditional random field or CRF) that combines multiple features which have been derived from query logs, web documents, dictionaries, etc. As used in this disclosure, a “term” might be either a word or phrase. In the relevant literature, the dropping of terms from a query is often referred to as “query relaxation”.

In operation 203, the data-mining software generates candidate queries by adding terms to the critical terms remaining in a unit, using a hybrid method based on co-occurrence of terms in query sessions, distributional similarity of terms in web documents, and term substitutions from other user queries that lead to a common uniform resource locator (URL). Then in operation 204, the data-mining software scores each candidate query on (a) its well-formedness (e.g., using statistical language models derived from query logs and web documents and a class-based language model), (b) relevance to the user query as determined by similarity measures (e.g., click-vector similarity, context-vector similarity, web-based-aboutness vector similarity, and web-result category similarity), and (c) utility. The data-mining software ranks and prunes scored candidate queries, e.g., by applying threshold to output of a gradient-boosting decision trees, in operation 205. Further details as to gradient boosting can be found in Friedman's Greedy function approximation: A gradient boosting machine, Annals of Statistics, 29: 1189-1232 (2000). Then in operation 206, the data-mining software stores the remaining scored candidate queries in a database (e.g., persistent storage 106) for subsequent real-time display (e.g., as suggested queries) in a browser GUI.

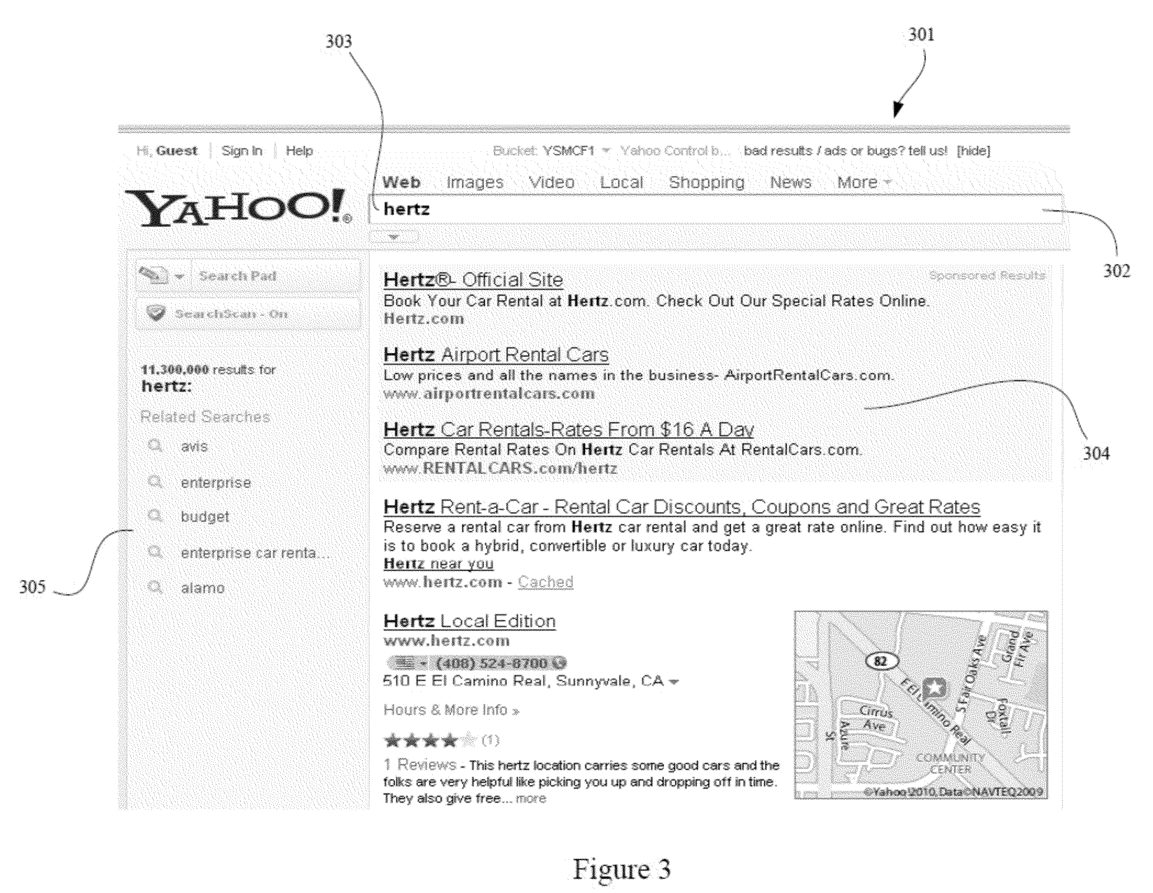

FIG. 3 shows an example of such a browser GUI. As depicted in this figure, browser GUI 301 includes a text box 302 into which a user has entered a query 301, namely, “hertz”. In response the entered query, a search engine (e.g., executing on a cluster of servers at a website) has retrieved (e.g., from a database or other persistent storage) an annotated list 304 of uniform resource locators (URLs), which are displayed in a view below the text box 302. Additionally, the search engine has retrieved (e.g., from a database or other persistent storage) a list 305 of suggested queries, which are displayed to the left of the annotated list 304 of URLs. It will be appreciated that the browser GUI 301 is intended as an example of how suggested queries might be displayed to a user who has entered a query. Of course, numerous other similar examples could have been offered (e.g., using the same or different GUI widgets) and are encompassed within this disclosure.

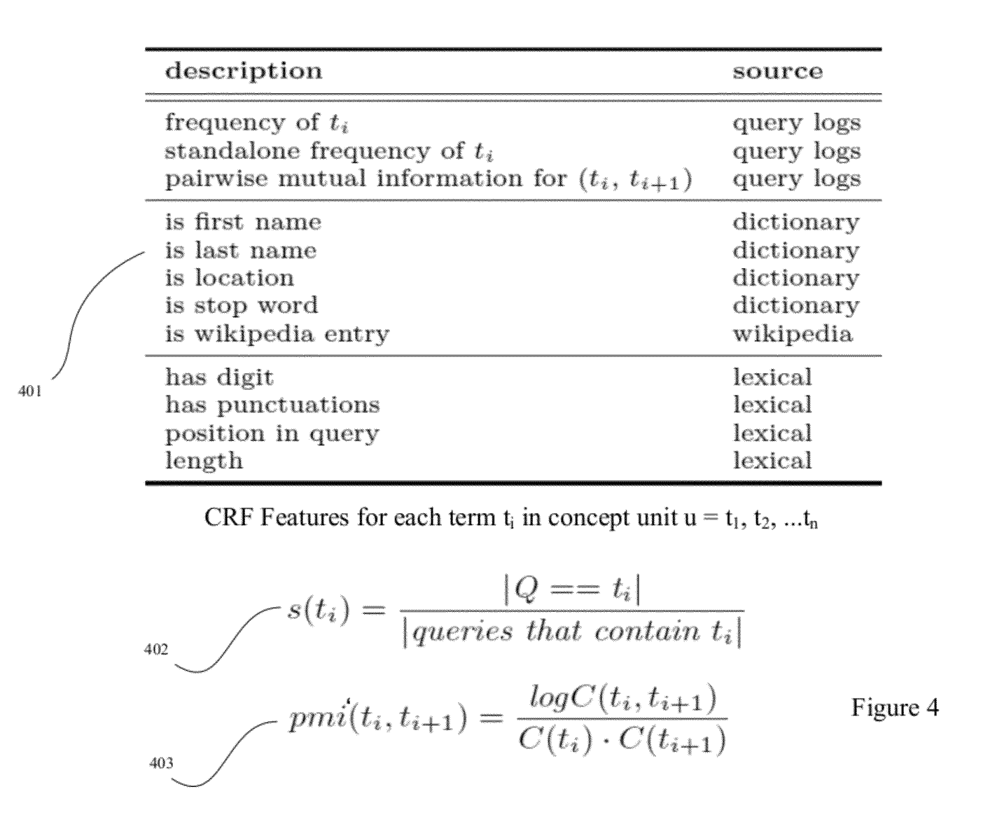

FIG. 4 shows a table 401 of Conditional Random Field (CRF) features that might be used to remove a term of lower importance from a concept unit, in accordance with an example embodiment. It will be appreciated that table 401 relates to operation 202 of the process depicted in FIG. 2 and that CRF is a labeling model which, after being trained on annotated data, allows for labeling a term as either critical (C) or dropped (D). For a general discussion of CRF training, see Conditional random fields: Probabilistic models for segmenting and labeling sequence data, ICML '01: 282-289 (2001) by Lafferty et al. In an example embodiment, some or all of the features in table 401 might be used in combination with each other. In another example embodiment, only one of the features might be used, e.g., standalone frequency of tᵢ which is described in further detail below, which has been shown to be an effective feature during empirical verification.

Each term tᵢ in a query q is associated with a number of CRF features whose descriptions and sources are listed in table 401. The first three features depend on query logs and are: (1) frequency of tᵢ; (2) standalone frequency of tᵢ; and (3) pairwise mutual information (pmi′) for (tᵢ and tᵢ₊₁). FIG. 4 shows the equation 402 for standalone frequency of tᵢ, where Q==t, is a query that consists solely of tᵢ. This feature captures whether or not a given term is an entity or a real-world concept. It will be appreciated that an entity or real-world concept (e.g., California, iPod, Madonna) will often occur in a standalone form in the query logs. FIG. 4 also shows the equation 403 for pairwise mutual information for (tᵢ and tᵢ₊₁), where C(tᵢ) is the number of queries that contain term tᵢ and C(tᵢ, tᵢ₊₁) is the number of queries that contain ordered pair (tᵢ, tᵢ₊₁). It will be appreciated that pmi′ measures the cohesiveness of pairs of terms (e.g., “San Francisco” has a higher pmi′ score than “drinking water”).

The next four features in table 401 depend on dictionaries: (1) “is first name”; (2) “is last name”; (3) “is location”; and (4) “is stop word”. It will be appreciated that a dictionary, as broadly defined, might itself be derived from other sources, e.g., web documents. The next feature in table 401 is “is wikipedia entry” and depends on the web pages associated with the Wikipedia website. The final four entries in table 401 are lexical and depend on the term t, itself: (1) “has digit”; (2) “has punctuations”; (3) “position in query”; and (4) “length”. It will also be appreciated that even at this point in the process depicted in FIG. 2, sources other than query logs are being used as inputs.

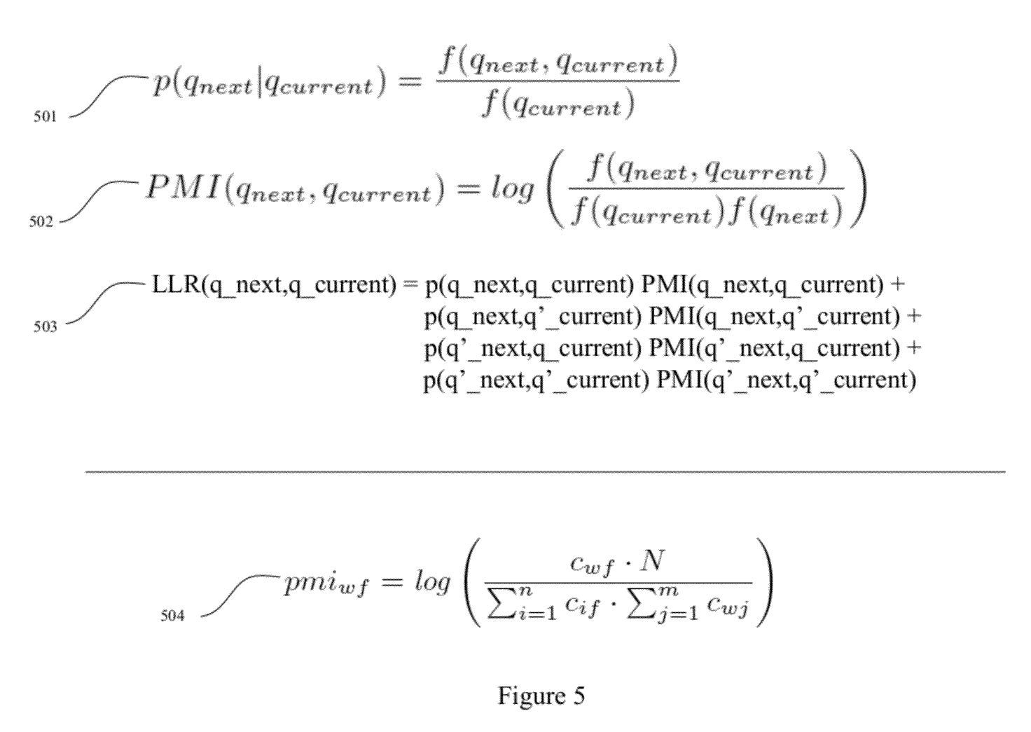

FIG. 5 shows descriptive statistics (e.g., co-occurrence of terms in query sessions and distributional similarity of terms in web documents) that are used to suggest terms for a candidate query suggestion, in accordance with an example embodiment. It will be appreciated that these statistics relate to operation 203 of the process depicted in FIG. 2. In an example embodiment, some or all of these descriptive statistics might be used in combination with each other and with other operations, e.g., term substitutions from other queries that lead to a common uniform resource locator (URL), in a hybrid method to suggest terms for a candidate query suggestion. In another example embodiment, only one of these statistics might be used, e.g., distributional similarity of terms in web documents.

In FIG. 5, equations 501, 502, and 503 pertain to co-occurrence of terms in query sessions. Here it will be appreciated that query sessions can be disaggregated from query logs. Equation 501 shows the probability p(qₙₑₓₜ|q_{current}) that a query q_{current} will be reformulated as a query qₙₑₓₜ as being equal to the frequency f(qₙₑₓₜ, q_{current}) that these two queries are issued by the same user within a short time frame (e.g., a co-occurrence of the queries) divided by the frequency f(q_{current}). It will be appreciated that this reformulation probability might include a qₙₑₓₜ that is not dependent on a q_{current}, e.g., a qₙₑₓₜ that has a high marginal probability. For further details on co-occurrence of terms in query sessions, see co-owned U.S. patent application Ser. No. 12/882,974, entitled Search Assist Powered by Session Analysis, by Lee et al., which is hereby incorporated by reference.

Equation 502 in FIG. 5 shows an alternative descriptive statistic, pointwise mutual information (pmi or PMI), that takes into account the dependency between f(q_{current}) and f(qₙₑₓₜ). According to this equation, PMI(qₙₑₓₜ, q_{current}) is equal to the log of a quotient, namely, the frequency f(qₙₑₓₜ, q_{current}) divided by the product of f(q_{current}) and f(qₙₑₓₜ). It will be appreciated that PMI might become unstable for pairs of rare queries. If f(q_{current}) and f(qₙₑₓₜ) are small enough, even a single coincidental co-occurrence might lead to a high value for PMI.

Equation 503 in FIG. 5 shows an alternative descriptive statistic, reformulation log likelihood (LLR), that avoids this instability by taking into account the size of the session data, e.g., when the marginal frequencies of f(q_{current}) and f(qₙₑₓₜ) are small, other terms in the equation dominate. According to this equation, LLR(qₙₑₓₜ, q_{current}) is equal to the sum of the product p(q_next,q_current)PMI(qnext, qcurrent), the product p(q_next,q′_current) PMI(q_next, q′_current), the product p(q′_next,q_current)PMI(q′_next, q_current), and the product p(q′_next,q′_current)PMI(q′_next, q′_current), where q′_next denotes the set of all queries except qnext and q′_current denotes the set of all queries except q′_current.

Equation 504 in FIG. 5 shows a descriptive statistic for distributional similarity of terms in web documents. According to the distributional hypothesis, words that occur in similar contexts tend to have similar meanings. Consequently, terms that are distributionally similar tend to be synonyms, hypernyms, siblings, etc.

In practice, distributional-similarity methods capture this hypothesis by recording the surrounding contexts for each term in a large collection of unstructured text and storing the contexts with the term in a term-context matrix. A term-context matrix consist of weights for contexts with terms as rows and context as columns, where each cell xᵢⱼ is assigned a weight to reflect the co-occurrence strength between the term i and context j. Methods differ in their definition of a context (e.g., text window or syntactic relations), or in their means to weight contexts (e.g., frequency, tf-idf, pmi), or in measuring the similarity between two context vectors (e.g., using Euclidean distance, Cosine similarity, Dice's coefficient, etc.).

In an example embodiment, the data-mining software builds a term-context matrix (e.g., during operation 203 in FIG. 2) by: (1) processing a relatively large corpus of web pages with a text chunker to generate terms that are noun-phrase chunks with some modifiers removed; (2) defining the contexts for each term was the resulting rightmost and leftmost stemmed chunks; and (3) creating a vector PMI(w), where PMI(w)=pmi_{w1}, Pmi_{w2}, . . . pmi_{wm}.

Equation 504 in FIG. 5 shows how each pmi_{wf} is calculated. In that equation, c_{wf} is the frequency of feature f occurring for term w, n is the number of unique terms, m is the number of contexts, and N is the total number of contexts for all terms. Once the term-context matrix is built, the data-mining software then uses the matrix (e.g., during operation 203 in FIG. 2) to calculate similarity scores between two terms by computing a cosine similarity between their PMI vectors. An example output of this distributionally-similar method might be “football hall of frame 2010 award winners”, given the query “football hall of frame 2010 inductees”, since “inductees” and “award winners” are distributionally similar phrases.

As noted above, operation 203 in FIG. 2 might also make use of substitutions from other queries (e.g., other user queries in query logs, relaxed queries, and/or candidate queries) that lead to a common uniform resource locator (URL). Such substitutions from user queries in query logs are generally discussed in Query recommendation using query logs in search engines: 588-596 (2005), by Baeza-Yates et al. In an example embodiment, the data-mining software constructs (e.g., during operation 203 in FIG. 2) a query-URL graph, where the edges are (a) 1 for a query and a URL that have been clicked with a click-through rate greater than 0.01 for that query and (b) 0 otherwise. It will be appreciated that this query-URL graph is a bipartite graph, as there are no edges between pairs of queries and pairs of URLs. Using this graph, the data-mining software identifies the query pairs that are connected to at least 2 and at most 10 common URLs. From the identified query pairs, the data-mining software searches for “substitutables”, e.g., context-aware synonyms, for terms that were dropped during query relaxation. For example, for the query “turkey recipes”, substitutables for a dropped term “recipes” might be “roasting times”, “stuffing recipe”, “how to roast”, etc. And then the substitutables are added to the critical terms to generate candidate queries such as “turkey roasting times”, “turkey stuffing recipe” and “how to roast turkey”.

If an upper bound such as 10 is not used when identifying query pairs, the resulting URL sets might tend to become identical and therefore not useful for generating substitutables. Likewise, the data-mining software might eliminate URLs that are connected to more than 200 queries, most of which turn out to be popular destination pages like youtube.com, amazon.com, etc., in an example embodiment. Such URLs might tend to bring in numerous irrelevant substitutables.

Similarly, if the data-mining software detects that less than 30 unique queries lead to a click to a URL (e.g., www.foo.com/menu.html) in a particular domain (e.g., www.foo.com), the data-mining software might classify the domain as a “tail domain” and associates pairs of queries with the domain, rather than the URLs in the domain, when constructing the bipartite graph. It will be appreciated that this use of a tail domain enriches the set of substitutables without loss of context.

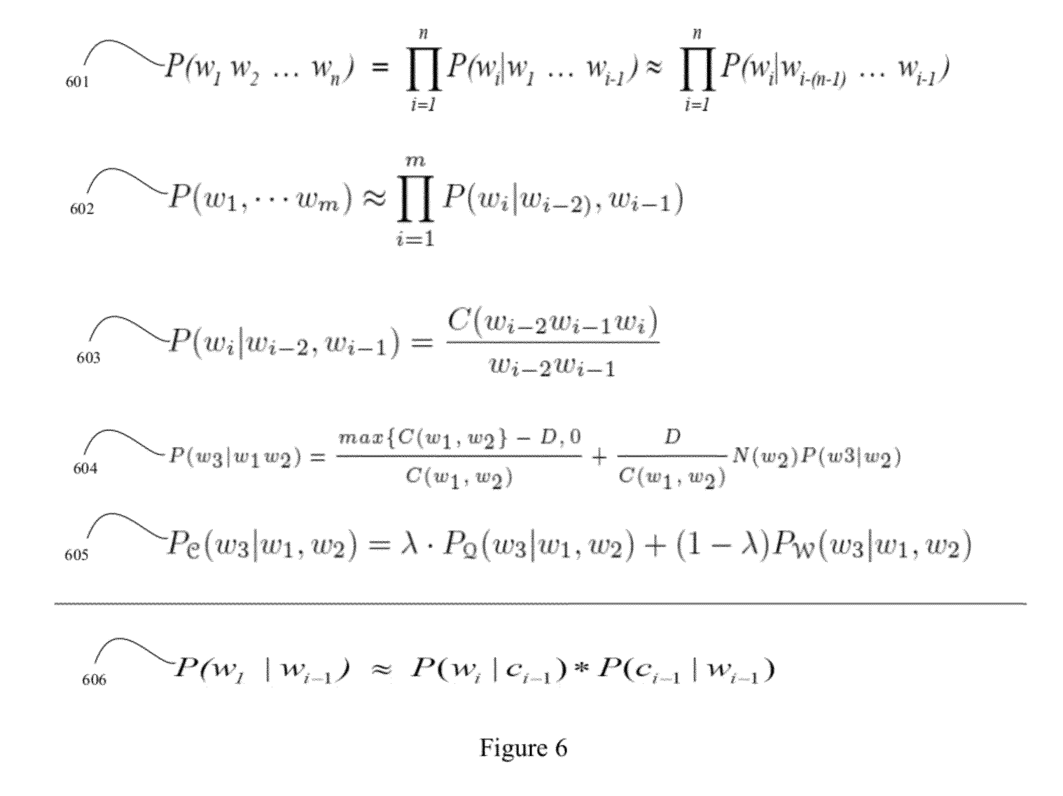

FIG. 6 shows statistical language models and a class-based language model that are used to calculate a score for the well-formedness of a candidate query suggestion, in accordance with an example embodiment. It will be appreciated that these models relate to operation 204 of the process depicted in FIG. 2. In an example embodiment, some or all of these models might be used in combination with each other to calculate a score for well-formedness. In another example embodiment, only one of these models might be used.

In general, a statistical language model is a probability distribution P(s) over a sequence w₁, w₂, . . . wₘ of words as shown in equation 601 in FIG. 6. The last term in equation 601 is an n-gram statistical language model that computes a probability distribution based on a “memory” consisting of the past n−1 words. In an example embodiment, the data-mining software might use approximation 602, which is a tri-gram statistical language model. The probability distribution for this tri-gram statistical language model is estimated using the maximum likelihood estimator shown in equation 603, where C(wᵢ₋₂wᵢ₋₁wᵢ) is the relative frequency of observing the word wᵢ given that it is preceded by the sequence wᵢ₋₂wᵢ₋₁.

A common problem in building statistical language models is word sequences that do not occur in the training set for the model, e.g., the model described equation 603. In the event of such a word sequence, C(wᵢ₋₂wᵢ₋₁wᵢ) equals 0, causing P(wᵢ|wᵢ₋₂,wᵢ₋₁) to also equal 0. To address this problem, the data-mining software might use Kneser-Ney smoothing which interpolates higher-order models with lower-order models based on the number of distinct contexts in which a term occurs instead of the number of occurrences of a word. Equation 604 shows the probability distribution P(w₃|w₁w₂) with such smoothing, where D is a discount factor and N(wᵢ) is the number of unique contexts following term wᵢ.

As indicated above, the candidate queries synthesized by the data-mining software are derived from web documents as well as query logs. Consequently, when determining the well-formedness of these candidate queries, the data-mining software combines a statistical language model based on web document (e.g., P_{W}) and a statistical language model based on query logs (e.g., P_{Q}), as shown in equation 606, where λ is the interpolation weight optimized on a heldout training set.

Approximation 606 in FIG. 6 shows a class-based language model, where Cᵢ is a class to which word wᵢ might belong. For example, the data-mining software might have mined the queries “chase online banking” and “wells fargo online banking” from the query logs. However, the query logs do not contain “citibank online banking”. Nonetheless, the data-mining software might synthesize such a candidate query using a class-based language model if a class for banks existed, e.g., Banks={chase, wells fargo, Citibank}. In an example embodiment, such a class-based language model might be used in combination with the statistical language models described above to calculate a score for well-formedness, e.g., through an equation similar to equation 605 in which three interpolation weights (e.g., λ₁, λ₂, and λ₃) sum up to 1. In an example embodiment, the classes and their instances for a class-based language model might be predefined by a human domain expert. In an alternative example embodiment, the classes and their instances for a class-based language model might be generated using software, e.g., neural networks, genetic algorithms, conceptual clustering, clustering analysis, etc.

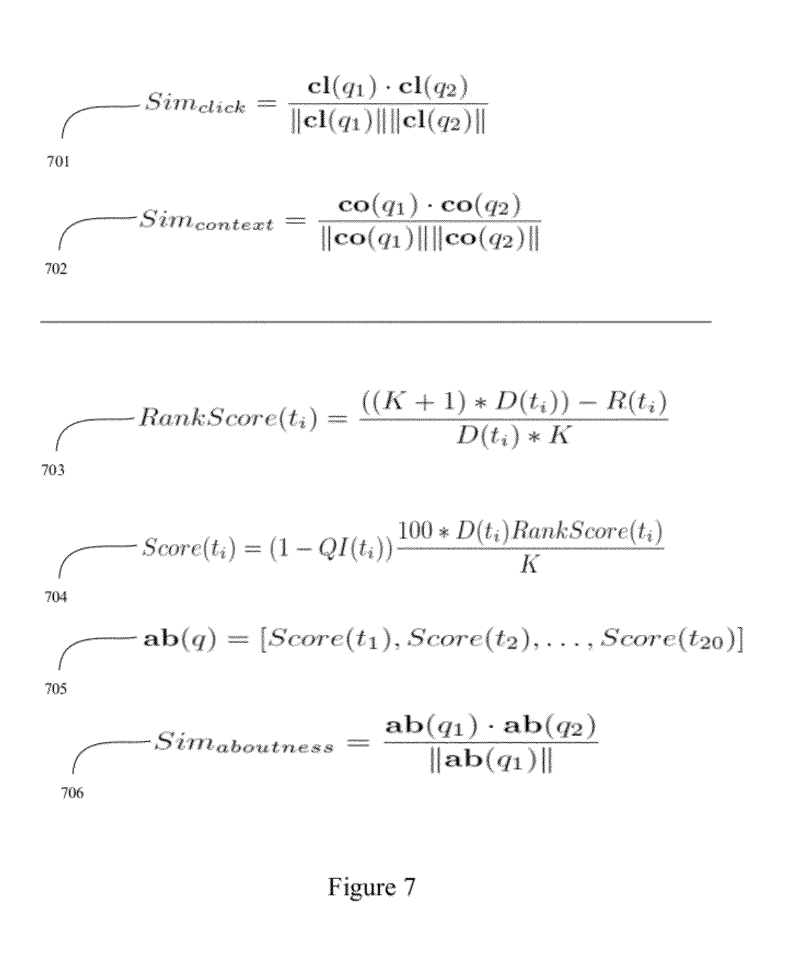

FIG. 7 shows similarity vectors (e.g., a click vector, a context vector, and a web-based-aboutness vector) that are used to calculate a score for relevance to a user query, in accordance with an example embodiment. It will be appreciated that these similarity vectors also relate to operation 204 of the process depicted in FIG. 2. In an example embodiment, some or all of these similarity vectors might be used in combination with each other and with other similarity vectors, e.g., web-result category similarity as described below. In another example embodiment, only one of these similarity vectors might be used, e.g., web-based-aboutness similarity, which has been shown to be an effective similarity vector during empirical verification.

Equation 701 in FIG. 7 shows an equation for click-vector similarity (Sim_{click}). In an example embodiment, click-vector similarity might be calculated using the query-URL graph described above. As used in Equation 701, cl(q)=[cl₁(q), cl₂(q), . . . cl_{K}(q)] is a click vector for query q and K is the number of clicked URLs. It will be appreciated that Sim_{click} is the cosine similarity for the click vectors for a query pair, e.g., query q₁ and candidate query q₂. By definition, Sim_{click} is non-zero for candidate queries derived from the query-URL graph.

Equation 702 in FIG. 7 shows an equation for context-vector similarity (Sim_{context}). To understand how relevance arises from contexts, consider an example where query logs show that the most frequent contexts for two queries, q₁ and q₂, are “<q₁> download”, “<q₂> download”, “install <q₁>”, and “install <q₂>”. From these contexts, it can be determined that both queries are relevant to software.

As used in equation 702, co(q)=[f₁, f₂, . . . f_{L}] is a context vector that includes the frequency fᵢ of each term that is searched along with a query q and L is the number of such terms (e.g., co-queried terms) in a query session recorded in the query logs. It will be appreciated that Sim_{context} is the cosine similarity for the context vectors for a query pair, e.g., query q₁ and candidate query q₂. It will be also appreciated that context-vector similarity is analogous in some ways to the distributional hypothesis discussed earlier.

Equations 703-706 in FIG. 7 are used during the calculation of web-based-aboutness similarity, which builds on the Prisma term-suggestion tool incorporated in the Alta Vista search engine. Prisma is described in detail in Anick's Using terminological feedback for web search refinement: a log-based study, SIGIR '03: 88-95 (2003), which is hereby incorporated by reference. In an example embodiment, the data-mining software might generate an aboutness vector through the following operations: (a) retrieve the top K ranked results (e.g., web documents) for a query q; (b) for each term tᵢ in a concept dictionary (as described by Anick), compute the term's RankScore (or average inverted rank of documents containing tᵢ) using equation 703 in FIG. 7, where D(tᵢ) is the number of results in which tᵢ appears and R(tᵢ) is the total rank for tᵢ; (c) compute QI(tᵢ), which is a Boolean variable that indicates whether tᵢ is in q; (d) if QI(tᵢ) is true, set Score(tᵢ) to 0, otherwise compute the Score using equation 704 in FIG. 7; (d) use the 20 concept terms (tᵢ) with the highest relative scores to build an aboutness vector for q as shown by equation 705 in FIG. 7; and (e) calculate Sim_{aboutness} as the cosine similarity between two queries, e.g., query q₁ and candidate query q₂, using equation 706 in FIG. 7.

During empirical verification, queries “python” and “ruby” had a significant Sim_{aboutness} score, with common aboutness terms “download”, “programming language”, and “implementation”. It will be appreciated that this result is relatively probative, given that the primary sense of the word “python” is a kind of snake and the primary sense of the word “ruby” is a kind of gemstone; only recently have these words taken on senses related to software. Further, it will be appreciated that Sim_{aboutness} has relatively full coverage, since the measure can be computed if a query returns at least some results, e.g., web documents.

As mentioned above, web-result category similarity might also be used to score candidate queries for relevance to a user query, in an example embodiment. This similarity is analogous to web-based-aboutness similarity. However, instead of using weight vectors that depend on terms in a concept dictionary, the data-mining software might use weight vectors that depend on the terms in a category (or class) in a semantic taxonomy. These weight vectors might then be used to calculate web-result category similarity as the cosine similarity between two queries, e.g., query q₁ and candidate query q₂. In an example embodiment, the categories (or classes) in a semantic taxonomy might be predefined by a human domain expert. In an alternative example embodiment, the categories or classes in a semantic taxonomy might be generated using software, e.g., neural networks, genetic algorithms, conceptual clustering, clustering analysis, etc.

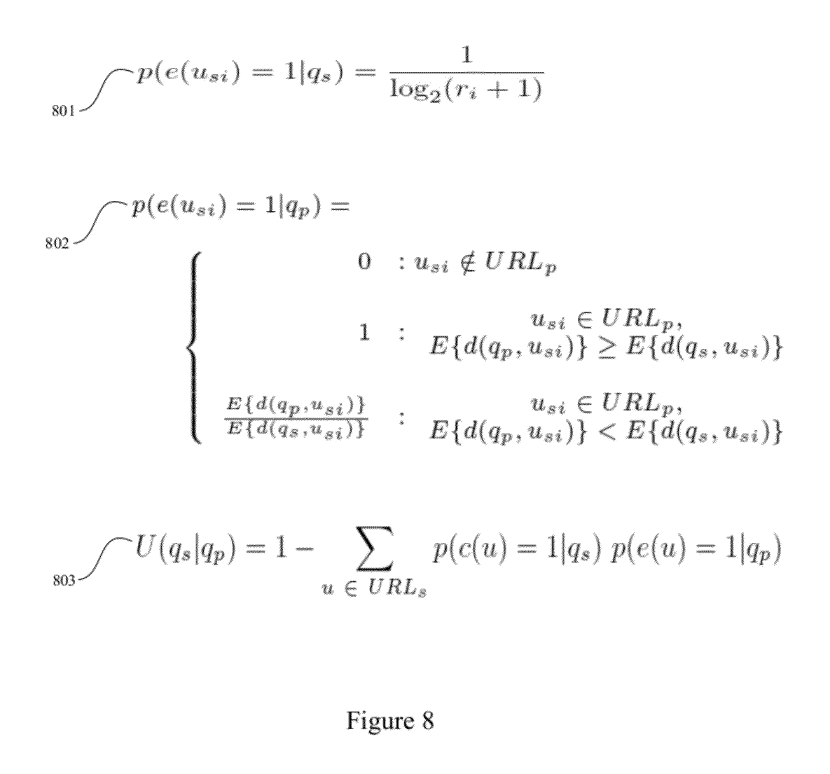

FIG. 8 shows a descriptive statistic (e.g., pairwise conditional utility) that is used to measure the utility of a candidate query suggestion, in accordance with an example embodiment. It will be appreciated that this descriptive statistic relates to operation 204 of the process depicted in FIG. 2.

Equation 801 in FIG. 8 shows the probability p that a URL usᵢ in the top 10 URLs will be examined given a suggestion query qₛ, where URL_{qs}=[us₁, . . . , us_{N}] are the set of URLs that result from qₛ, rᵢ is the rank of the URL, and e is a binary random variable that shows whether the URL is examined or not. It will be appreciated that equation 801 is a Discounted Cumulated Gain (DCG) formula as described in Cumulated gain-based evaluation of IR techniques, ACM Trans. Inf. Syst., 20(4): 422-446 (2002) by Jarvelin et al. Similarly, Equation 802 in FIG. 8 shows the probability p that a URL usᵢ will be examined given a presented (or an original) query qₚ, where URL_{qp}=[us₁, . . . , us_{N}] are the set of URLs that result from qₚ, e is again a binary random variable that shows whether the URL is examined or not, E denotes expected value, and d denotes a rank discount. Here it will be appreciated that usᵢ cannot be observed via qₚ, if it is not in the result set of qₚ, hence the examination probability is zero in that event. Also, if qₚ returns usᵢ with an expected rank discount at least as high as qₛ does, the examination probability is 1. And if qₚ returns usᵢ with an expected rank discount lower than qₛ does, the examination probability of this URL is the ratio of the expected rank discounts.

Equation 803 in FIG. 8 shows the equation for pairwise conditional utility. It will be appreciated that this equation combines equations 801 and 802. In words, the first term in the summation in equation 803 measures how important a particular URL is for the query qₛ. The second term in the summation in equation 803 measures how likely it is that the same user would examine the URL in qₚ, with the assumption that the user would go as deep into the result set in qₚ as in the result set for qₛ. It will be appreciated that U(qₛ|qₚ) is, by definition, zero if the results of the two queries are exactly the same or if qₛ has zero results. Also, U(qₛ|qₚ) would be close to zero for queries that share and rank many URLs similarly.

The inventions described above and claimed below may be practiced with other computer system configurations including hand-held devices, microprocessor systems, microprocessor-based or programmable consumer electronics, minicomputers, mainframe computers and the like. The inventions might also be practiced in distributing computing environments where tasks are performed by remote processing devices that are linked through a network.

With the above embodiments in mind, it should be understood that the inventions might employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the inventions are useful machine operations. The inventions also relate to a device or an apparatus for performing these operations. The apparatus may be specially constructed for the required purposes, such as the carrier network discussed above, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The inventions can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, DVDs, Flash, magnetic tapes, and other optical and non-optical data storage devices. The computer readable medium can also be distributed over a network coupled computer systems so that the computer readable code is stored and executed in a distributed fashion.

Although example embodiments of the inventions have been described in some detail for purposes of clarity of understanding, it will be apparent that certain changes and modifications can be practiced within the scope of the following claims. For example, the operations described above might be used to synthesize suggested queries from textual documents other than web documents. Or the operations described above might be used in conjunction with personalization based on web usage. Moreover, the operations described above can be ordered, modularized, and/or distributed in any suitable way. Accordingly, the present embodiments are to be considered as illustrative and not restrictive, and the inventions are not to be limited to the details given herein, but may be modified within the scope and equivalents of the following claims. In the following claims, elements and/or steps do not imply any particular order of operation, unless explicitly stated in the claims or implicitly required by the specification and/or drawings.

What is claimed is:

1. A method for synthesizing suggestions for web-search queries, comprising the operations of:
receiving a user query as an input and segmenting the user query into a plurality of units;
dropping at least one term from a unit using a labeling model that combines a plurality of features, wherein at least one of the features is derived from query logs and at least one of the features is derived from web documents;
generating one or more candidate queries by adding at least one term to the unit, wherein the added term results from a hybrid method based at least in part on co-occurrence of terms in query sessions, distributional similarity of terms in web documents, and term substitutions from other user queries that lead to a common uniform resource locator (URL);
scoring each candidate query based at least in part on well-formedness of the candidate query, utility, and relevance to the user query, wherein the relevance depends at least in part on a similarity measure; and
storing at least one of the scored candidate queries in a database for subsequent display in a graphical user interface for a search engine, wherein each operation of the method is executed by a processor.

2. The method of claim 1, wherein the labeling model is model that uses conditional random fields (CRF).

3. The method of claim 1, wherein the similarity measure includes a measure of aboutness based on web documents.

4. The method of claim 3, wherein the similarity measure is web-based-aboutness similarity.

5. The method of claim 1, wherein the similarity measure is click-vector similarity.

6. The method of claim 1, wherein the similarity measure is context-vector similarity.

7. The method of claim 1, wherein the similarity measure includes a measure of category similarity for web results.

8. The method of claim 1, wherein at least one of the features is derived from a dictionary.

9. The method of claim 1, wherein well-formedness depends at least in part on a statistical language model based on query logs and a statistical language model based on web documents.

10. The method of claim 1, wherein well-formedness depends at least in part on a class-based language model.

11. A computer-readable storage medium persistently storing software that when executed instructs a processor to perform the following operations:
receive a user query as an input and segment the user query into a plurality of units;
drop at least one term from a unit using a labeling model that combines a plurality of features, wherein at least one of the features is derived from query logs and at least one of the features is derived from web documents;
generate one or more candidate queries by adding at least one term to the unit, wherein the added term results from a hybrid method based at least in part on co-occurrence of terms in query sessions, distributional similarity of terms in web documents, and term substitutions from other user queries that lead to a common uniform resource locator (URL);
score each candidate query based at least in part on well-formedness of the candidate query, utility, and relevance to the user query, wherein the relevance depends at least in part on a similarity measure; and
store at least one of the scored candidate queries in a database for subsequent display in a graphical user interface for a search engine.

12. The computer-readable storage medium as in claim 11, wherein the labeling model is model that uses conditional random fields (CRF).

13. The computer-readable storage medium as in claim 11, wherein the similarity measure includes a measure of aboutness based on web documents.

14. The computer-readable storage medium as in claim 13, wherein the similarity measure is web-based-aboutness similarity.

15. The computer-readable storage medium as in claim 11, wherein the similarity measure is click-vector similarity.

16. The computer-readable storage medium as in claim 11, wherein the similarity measure is context-vector similarity.

17. The computer-readable storage medium as in claim 11, wherein the similarity measure includes a measure of category similarity for web results.

18. The computer-readable storage medium as in claim 11, wherein well-formedness depends at least in part on a statistical language model based on query logs and a statistical language model based on web documents.

19. The computer-readable storage medium as in claim 11, wherein well-formedness depends at least in part on a class-based language model.

20. A method for synthesizing suggestions for web-search queries, comprising the operations of:
receiving a user query as an input and segmenting the user query into a plurality of units;
dropping at least one term from a unit using a Conditional Random Field (CRF) model that combines a plurality of features, at least one of which is a standalone score for a term, and wherein at least one of the features is derived from query logs and at least one of the features is derived from web documents;
generating one or more candidate queries by adding at least one term to the unit, wherein the added term results from a hybrid method that utilizes query sessions and a web corpus;
scoring each candidate query based at least in part on the relevance to the user query, wherein the relevance depends at least in part on web-based-aboutness similarity; and
storing at least one of the scored candidate queries in a database for subsequent display in a graphical user interface for a search engine, wherein each operation of the method is executed by a processor.
